(19) United States
(12) Patent Application Publication
(10) Pub. No.: US 2025/0326895 A1
(43) Pub. Date: Oct. 23, 2025

(54) BIOGENIC CATALYSTS FOR SULFUR POLYMERIZATION

(71) Applicants: Elham Fini, Phoenix, AZ (US); Masoumeh Mousavi, Tempe, AZ (US)

(72) Inventors: Elham Fini, Phoenix, AZ (US); Masoumeh Mousavi, Tempe, AZ (US)

(21) Appl. No.: 19/185,622

(22) Filed: Apr. 22, 2025

Related U.S. Application Data
(60) Provisional application No. 63/637,012, filed on Apr. 22, 2024.

(51) Int. Cl. C08G 75/14

(52) U.S. Cl. CPC C08G 75/14

(57) ABSTRACT

Synthesizing a polysulfide copolymer by inverse vulcanization includes combining elemental sulfur with a biogenic catalyst to yield a first mixture, heating the first mixture to form a melt including polysulfide chains, combining one or more unsaturated fatty acids with the melt to yield a second mixture, and copolymerizing the polysulfide chains and the one or more unsaturated fatty acids in the second mixture to yield the polysulfide copolymer.

### CROSS-REFERENCE TO RELATED APPLICATION

This application claims the benefit of U.S. Patent Application No. 63/637,012 filed on Apr. 22, 2024, which is incorporated by reference herein in its entirety.

### STATEMENT OF GOVERNMENT SUPPORT

This invention was made with government support under 1935723 awarded by the National Science Foundation. The government has certain rights in the invention.

### TECHNICAL FIELD

This invention relates to biogenic catalysts for inverse vulcanization of sulfur with fatty acid crosslinkers to form polymers.

### BACKGROUND

Inverse vulcanization of sulfur is a process that involves polymerization of elemental sulfur and organic co-monomers to yield polysulfide polymers with organic linkers. This process begins with the heating of elemental sulfur above its melting point (115.21° C.) to favor the ring-opening polymerization process of the S₈ monomer, which occurs at 159° C. As a result, the liquid sulfur—which also acts as a solvent—is constituted into linear polysulfide chains with diradical ends, which can be bridged and/or crosslinked together with dienes. The behavior of elemental sulfur at high temperature is described by: 1) ring-opening polymerization, which is a reversible process in which the broken bonds of S₈ rings are covalently bound to each other to generate long chains of sulfur; and 2) ring-closing depolymerization, in which the unstable radicals of sulfur are bound to one another to produce S₈ or other cyclic sulfur species. The reversibility of the sulfur chains (the formation of cyclic sulfurs) increases the crystalline state of sulfur in the medium and increases the brittleness of the polymer. Thus, the terminal radicals of sulfur are typically quenched to yield more useful polymers.

### SUMMARY

The present disclosure describes synthesis of polysulfide copolymers by inverse vulcanization using biogenic catalysts and renewable crosslinkers. This inverse vulcanization process provides a sustainable valorization solution for the problem of excess sulfur arising from abundant natural sources of sulfur and the production of waste sulfur as a by-product of oil refineries.

In a first general aspect, synthesizing a polysulfide copolymer by inverse vulcanization includes combining elemental sulfur with a biogenic catalyst to yield a first mixture, heating the first mixture to form a melt including polysulfide chains, combining one or more unsaturated fatty acids with the melt to yield a second mixture, and copolymerizing the polysulfide chains and the one or more unsaturated fatty acids in the second mixture to yield the polysulfide copolymer.

Implementations of the first general aspect may include one or more of the following features.

In some cases, the elemental sulfur includes waste sulfur. The waste sulfur can be a by-product of hydrosulfurization processing. The biogenic catalyst can include biochar. The biochar can include two or more metals. The two or more metals can be selected from Si, Ca, K, Al, Na, Fe, P, Mg, Mn, Zn, Pb, and Ti. In certain implementations, the biochar includes biochar from algae, grasses, wood, shells, crops, crop waste, or organic waste. The wood can include pine, acacia, walnut, fir, and birch. The grasses can include miscanthus. The organic waste can include waste from wastewater treatment processes, paper mills, sawmills, or breweries.

In certain cases, the one or more unsaturated fatty acids has 12 carbon atoms to 22 carbon atoms. The one or more unsaturated fatty acids can include linoleic acid, oleic acid, or a combination thereof. In some examples, the one or more unsaturated fatty acids are derived from one or more plant-based oils. The one or more plant-based oils can include canola oil, linseed oil, sunflower oil, olive oil, or any combination thereof. In some cases, the one or more plant-based oils include waste vegetable oil.

A weight ratio of a total amount of the one or more unsaturated fatty acids to the elemental sulfur can be in a range of about 0.1 to about 0.3. In certain cases, a weight ratio of a total amount of the biogenic catalyst to a total amount of sulfur is in a range of about 0.0001 to about 0.001.

In some examples, heating the first mixture includes heating in a temperature range of about 130° C. to about 170° C. The copolymerizing can include heating in a temperature of about 110° C. to about 145° C.

In some implementations, the one or more unsaturated fatty acids include oleic acid, and the biogenic catalyst includes Ti, Mg, or Zn. In one example, a catalytic activity of the biogenic catalyst including Ti exceeds a catalytic activity of the biogenic catalyst including Mg, and the catalytic activity of the biogenic catalyst including Mg exceeds a catalytic activity of the biogenic catalyst including Zn.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1A is a flow chart showing operations in a process for synthesizing a polysulfide copolymer by inverse vulcanization. FIG. 1B shows the versatile coordination behavior of the carboxylate head of fatty acids toward metal ions.

FIG. 2 shows a comparison of the stability of three metal oleates (Ti, Mg, and Zn oleates) based on their binding interactions between oleate (C₁₈H₃₃O₂)⁻ and metal oleate (M-C₁₈H₃₃O₂)ⁿ⁺ constituents within their coordination complexes.

FIG. 3 shows viscosity values for the blends of sulfur-oleic acid with and without catalysts.

FIG. 4A shows a differential scanning calorimetry (DSC) curve of elemental sulfur.

FIG. 4B shows a DSC curve of the sample catalyzed by algae (AL) biochar. FIG. 4C shows a DSC curve of the sample catalyzed by silver grass-biochar.

FIGS. 5A-5D show rheological profiles of sulfur-polymer samples catalyzed by silver grass and Zn(DTC)₂. FIG. 5A shows the rheological profiles of the storage modulus and loss modulus for the sample catalyzed with Zn(DTC)₂. FIG. 5B shows the rheological profiles of the storage modulus and loss modulus for the sample catalyzed with silver grass. FIG. 5C shows a comparison of the rheological profiles of the loss modulus of Zn(DTC)₂ and the silver grass-catalyzed samples. FIG. 5D shows a comparison of the rheological profiles of the storage modulus for both Zn(DTC)₂ and silver grass-biochar catalyzed samples.

FIG. 6 shows a comparison of glass transition temperatures (T_{g}) for samples catalyzed by Zn(DTC)₂ and silver grass-biochar.

FIG. 7 shows a comparison of the moisture-induced shear-thinning index (MISTI) for sulfur-polymer samples catalyzed by silver grass and sulfur-polymer samples catalyzed by Zn(DTC)₂.

FIG. 8 is a schematic depicting S—S bond breaking of elemental sulfur, S₈, in the presence of zinc diethyldithiocarbamate, Zn(DTC)₂, as a well-known catalyst for inverse vulcanization. The reaction is performed using DFT calculations.

### DETAILED DESCRIPTION

The present disclosure provides a method of preparation of polysulfide copolymers by inverse vulcanization of sulfur using biogenic catalysts and renewable crosslinkers. As described herein, “biogenic catalysts” generally refer to biochar containing two or more metals. Examples of metals present in biochar include Si, Ca, K, Al, Na, Fe, P, Mg, Mn, Zn, Pb, and Ti. Biochar is a porous and solid carbonaceous substance obtained through the thermal decomposition of biomass under restricted oxygen conditions. Classified as a form of biocarbon, biochar encompasses diverse carbon materials originated from biological sources such as plants, animals, and microbes. Examples of sources of biochar include algae, wood, shells, crops, crop waste, and other organic waste (e.g., from wastewater treatment, paper mills, sawmills, or breweries). Some biochar, such as that derived from miscanthus (silver grass), contains minerals such as Si, Zn, and Mg, which act as catalysts, while the carbon-containing portion of the biochar functions as the catalyst support. Renewable crosslinkers include unsaturated plant-based oils as well as unsaturated fatty acids (e.g., fatty acids having 12-22 carbon atoms, including oleic acid and linoleic acid).

In conventional vulcanization, where sulfur is a vulcanizing agent (crosslinker), and in inverse vulcanization, where sulfur reacts with vulcanizing agents (crosslinkers), high temperatures (e.g., 160° C. to 200° C.) and prolonged heating times are typically required for stable polymer formation. These temperature conditions can promote the formation of toxic by-products, such as H₂S. Comparative experiments conducted with and without a catalyst showed that the catalyzed reactions resulted in up to a sevenfold reduction in H₂S production. High temperatures can also limit the choice of monomers to those that are predominantly non-volatile at the reaction temperatures (e.g., monomers with a high boiling point).

The chemical nature of the crosslinkers can play a role in mechanical properties (e.g., stiffness and strength) of the sulfur polymers. Unsaturated vegetable oils, such as canola oil, linseed oil, sunflower oil, and olive oil, are effective crosslinkers for sulfur chains, resulting in the formation of soft, flexible polymers. Fatty acids, the building blocks of vegetable oils and plant oils, can also be used as crosslinkers.

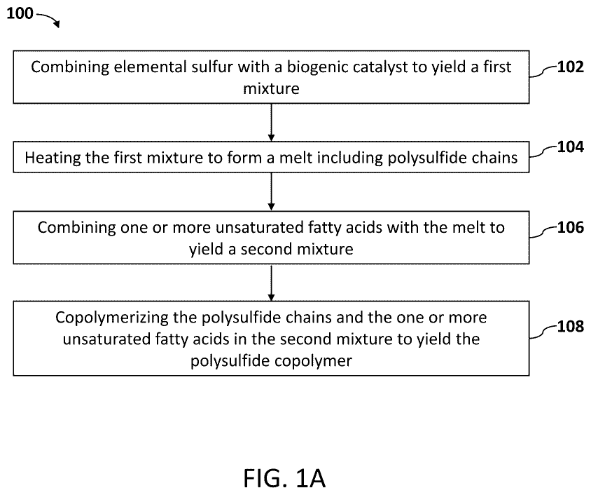

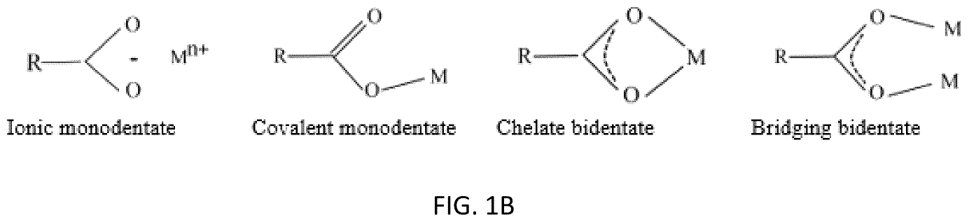

FIG. 1A is a flow chart showing operations in process 100 for synthesizing a polysulfide copolymer by inverse vulcanization. In 102, elemental sulfur is combined with a biogenic catalyst to yield a first mixture. An example of elemental sulfur includes waste sulfur. In some cases, the waste sulfur is a by-product of hydrodesulfurization processing. The biogenic catalyst typically includes biochar and the biochar typically includes two or more metals. Examples of suitable metals include Si, Ca, K, Al, Na, Fe, P, Mg, Mn, Zn, Pb, and Ti. The biochar typically includes biochar from algae, grasses, wood, shells, crops, crop waste, or organic waste. In some cases, the grasses include miscanthus. Examples of suitable wood include pine, acacia, walnut, fir, and birch. The organic waste typically includes waste from wastewater treatment processes, paper mills, sawmills, or breweries.

In 104, the first mixture is heated to form a melt including polysulfide chains to improve fluidity. The heating of the first mixture typically includes heating in a temperature range of about 130° C. to about 170° C. (e.g., 140° C.). In 106, one or more unsaturated fatty acids are combined with the melt to yield a second mixture. Each of the one or more unsaturated fatty acids typically has 12 to 22 carbon atoms. Examples of suitable unsaturated fatty acids include linoleic acid, oleic acid, or any combination thereof. In some cases, the one or more unsaturated fatty acids are derived from one or more plant-based oils. The one or more plant-based oils typically include canola oil, linseed oil, sunflower oil, olive oil, waste vegetable oil, or any combination thereof. A weight ratio of a total amount of the one or more unsaturated fatty acids to the elemental sulfur is typically in a range of about 0.1 to about 0.3 (e.g., 0.2). In some cases, a weight ratio of a total amount of the biogenic catalyst to a total amount of sulfur is in a range of about 0.0001 to about 0.001 (e.g., 0.0008).

In 108, the polysulfide chains and the one or more unsaturated fatty acids in the second mixture are copolymerized to yield the polysulfide copolymer. In some cases, the one or more unsaturated fatty acids include oleic acid and the biogenic catalyst includes Ti, Mg, or Zn. The copolymerizing typically includes heating in a temperature range of about 110° C. to about 145° C. (e.g., 120° C. to 140° C.). In some cases, the catalytic activity of the biogenic catalyst including Ti exceeds the catalytic activity of the biogenic catalyst including Mg, and the catalytic activity of the biogenic catalyst including Mg exceeds the catalytic activity of the biogenic catalyst including Zn.

### EXAMPLES

### Example 1. Vulcanization of Waste Sulfur with a Biogenic Catalyst

Experimental results demonstrated the efficacy of inverse vulcanization of waste sulfur with a biogenic catalyst (e.g., TiO₂) derived from biomass and a renewable monomer (oleic acid). These results were confirmed by density functional theory (DFT) calculations to gain insight into the molecular interactions between coordination complexes of Ti-oleate and sulfur chains. Laboratory experiments and rheological characterization were performed to evaluate the effectiveness of TiO₂ on inverse vulcanization in the copolymerization of oleic acid and sulfur.

Quantum-based molecular modeling using DFT was used to optimize the molecular models and to calculate interaction (binding) energies. The DMol³ module and its numerical basis sets, from BIOVIA Materials Studio, were used for DFT calculations. The Perdew-Burke-Ernzerhof (PB E) formulation of generalized gradient approximation was used as the exchange-correlation functional, and the long-range dispersion corrections (PBE-D) were included in the calculations using Grimme's correction. Double-numerical basis with a polarization function (DNP) was used as the basis set in an all-electron optimization, without imposing geometric or symmetrical constraints. At this level of calculation (PBE-D/DNP) and choosing fine numerical integration grid for the quality of calculations, the tolerances on energy, maximum force, and displacement convergence were 1.0×10⁻⁵ hartree, 2.0×10⁻³ hartree Å⁻¹, and 5.0×10⁻³ Å, respectively.

The interaction (binding) energy between the ionic complex of Ti-oleate and other oleate chains or sulfur chains was defined as the energy difference (AE) between the complex formed and its components when the components are in their lowest energy states. Elemental sulfur, oleic acid, magnesium oxide (MgO), zinc oxide (ZnO), and rutile titanium oxide (TiO₂) in reagent grade were acquired from Shanghai Macklin Biochemical Co., Ltd (Shanghai, China). Viscosity was measured using an NDJ-1D rotational viscometer from Shanghai Changji Geological Instrument Co., Ltd. (Shanghai, China).

Given the chosen experimental conditions, esterification was not expected for a mixture of TiO₂ and oleic acid: Ti-oleate crystals were not expected to form. Despite any chemical reaction in the medium of TiO₂-oleic acid in this example, DFT calculations were performed in the framework of the oleate interactions with Ti⁺⁴. The assumption in the predominance of oleate anions in the medium of TiO₂ aligned with the mechanism assessed for the interaction of oleic acid with ZnO₂ and binding of the oleates through the carboxylate group. The interaction mechanism was demonstrated by the predominance of the oleate ligands around the molecular units of Ti⁴⁺.

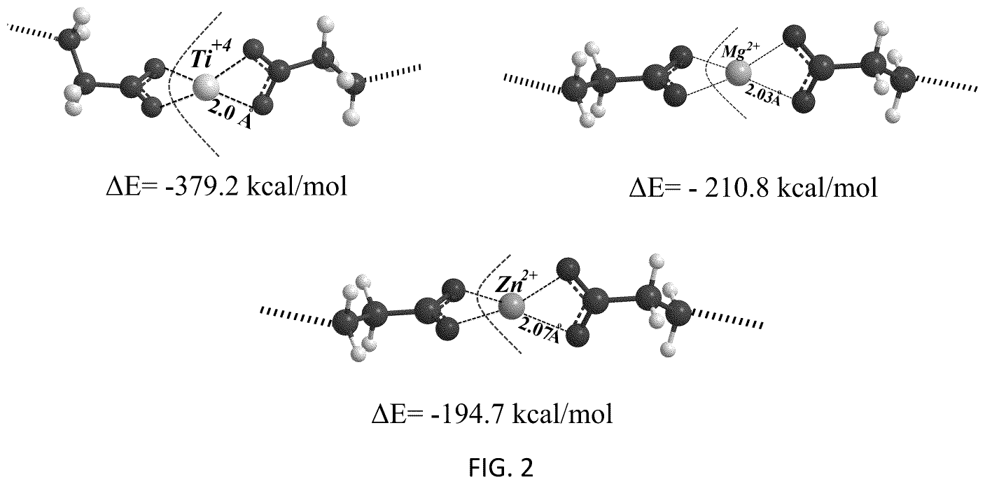

The DFT approach at the PBE-D/DNP level was used to gain insight into the molecular interactions among TiO₂, oleic acid, and sulfur chains. One goal was to better define the role of Ti in bringing the oleate chains into proximity to sulfur. Considering the poor miscibility between an organic crosslinker (e.g., oleic acid) and the inorganic phase of molten sulfur, a role of the metal oxide was to bring the crosslinker into a position in proximity to sulfur to facilitate the reaction between the two species and develop copolymerization. The chemical nature of the different metals and their binding interactions with oleate as well as sulfur chains was compared. As shown in FIG. 2, coordination complexes of Ti-oleate were better stabilized than Zn-oleate or Mg-oleate complexes. In this comparison, the same number of ligands have been attached to the central metal. The strength of binding interactions between (RCOO—Ti)⁺³ as the Lewis acid and RCOO⁻ as the Lewis base was ΔE=−379.2 kcal/mol, which was higher than (COO—Mg)⁺¹—RCOO⁻ with ΔE=−210.8 kcal/mol and (COO—Zn)⁺¹—RCOO⁻ with ΔE=−194.7 kcal/mol. The acidity of the metal complex was dependent on at least the size and charge of the metal. Ti⁺⁴ with the highest atomic radius (187 pm) and the charge of +4 compared to atomic radiuses of Mg (173 pm) and Zn (139 pm) with the charge of +2 benefitted from the highest electrostatic attraction, indicating that Ti⁺⁴ was the strongest acid in this group.

With respect to FIG. 2, the structure and stability of the activator, indicated by the interaction (binding) energy, was a factor in the reactivity of the activator; the activator was in the form of a pure metal oxide (e.g., TiO₂, MgO, ZnO) or a combination of metal oxides with sustainable ligands such as fatty acids or chemical ligands such as ethylene glycol dimethacrylate. On one side, a lower binding energy seemed more beneficial for the matrix at least in part because it was accompanied by the facile release of metal cations and further reactions with elements such as sulfur chains. On the other side, high stability and strong coordination bonds were factors for a metal complex in a thermal reaction.

Based on the DFT results, the binding energy of Mg-oleate (−210.8 kcal/mol) was slightly more than that of Zn-oleate (−194.7 kcal/mol), as shown in FIG. 2. Irrespective of the mode of binding of fatty acid to metal oxide, the binding energy of one oleate ligand to form Ti⁴⁺-oleate (ΔE=−379.2 kcal/mol) was higher than to form Mg-oleate (ΔE=−210.8 kcal/mol) or Zn-oleate (ΔE=−194.7 kcal/mol). While Zn²⁺ and Mg²⁺ were capable of coordinating with two oleate ligands, Ti⁴⁺ exhibited a higher coordination capacity, allowing it to coordinate with four oleate ligands. This indicated that Ti⁴⁺ was more capable of establishing a highly coordinated intermediate complex, compared to Zn²⁺ and Mg²⁺. However, DFT results suggested a decreasing trend in tendency for coordination of the oleate ligands to the Ti⁴⁺ with the increasing number of oleate ligands. The coordination of the third and fourth ligands to the Ti⁴⁺ was not as favorable as that of the first two ligands, at least in part because of the high steric hindrance around the metal ion. This result was supported by the values in binding energies: the binding energy of the fourth oleate ligand to the Ti⁺-complex (−139.8 kcal/mol) was about one-third of the binding energy of the second oleate ligand to the Ti³⁺-complex (−379.2 kcal/mol). The lower binding energy for the last two ligands increased the availability of the Ti ion and its reactivity toward the other active agents, including sulfur chains.

To gain an insight into the coordination geometry around the central metal ion and the steric hindrance that was formed in this zone, the coordination geometries of two oleate ligands and four oleate ligands around the Ti⁴⁺ metal ion were compared. In the DFT calculations, a bidentate coordinate or possibly an ionic monodentate, as shown in FIG. 1B, was observed for binding of each oleate ligand (carboxylate head, —COOH) to the Ti⁴⁺ metal ion that can be correlated with a covalent (donor-acceptor) or ionic molecular structure for Ti-oleate, respectively.

The low binding energy of a Ti²⁺⁽¹⁺⁾-oleate complex with the third and fourth oleate ligands can make the complex more accessible for other available agents, including sulfur chains. The availability of Ti ions could be a factor in promoting the crosslinking reactions and increasing the sulfur crosslinks in the inverse vulcanization process. While the two-prong head of the oleate ligand (carboxylate group), with its high steric hindrance, was not able to easily bind to the Ti ion, sulfur chains can use the free capacity of the Ti cation and coordinate to the Ti-oleate.

In the sea of sulfur chains, these intermediate complexes (e.g., Ti²⁺-dioleate and Ti⁺-trioleate) can be better targets for the sulfur chains than the oleic acid chains. In some cases, this can be at least in part because of the lower steric hindrance of sulfur chains compared to the carboxylate group of the oleate ligand. The availability of sulfur chains, due at least in part to their higher concentration in the medium compared to oleic acid chains, can also lead these intermediate complexes to be better targets for the sulfur chains. For a coordination complex of one Ti²⁺-dioleate and one oleate anion (Ti²⁺-dioleate-oleate), the binding interaction between one Ti²⁺-dioleate and one oleate anion (Ti²⁺-dioleate-oleate) was associated with −247.8 kcal/mol stabilization energy. For a coordination complex of the Ti⁺-trioleate with one sulfur chain replacing an oleate anion, the replacement of the oleate anion with a short chain of sulfur containing six sulfur atoms (HS) provided a binding energy of −210.5 kcal/mol, compared to the energy of Ti-dioleate-oleate (−247.8 kcal/mol). For a coordination complex of the Ti⁺-trioleate with two sulfur chains replacing an oleate anion to simulate the bidentate coordination of the carboxylate group, the interaction (Ti-dioleate-di-sulfur) was associated with −334.9 kcal/mol, which was higher than its counterpart. This suggested that TiO₂ can bring oleic acid in proximity to sulfur to facilitate the reaction between the two species and develop copolymerization.

To evaluate the function of radical chains of sulfur toward intermediate complexes of Ti-oleate, the interactions of Ti³⁺-monooleate with 18-atom sulfur chains were assessed. The energy values from sulfur radicals were lower than the values from sulfur anions. Electrostatic interaction of a negatively charged ion of sulfur with a positively charged ion of metal was stronger than the interaction of a sulfur radical with a metal ion, at least in part because the radicals are still neutral species. A coordination complex of sulfur-Ti³⁺-oleate was associated with −173.8 kcal/mol for a radical-terminated sulfur chain and was −376.5 kcal/mol for a negatively charged sulfur chain reaction. A comparison of the binding energy of Ti²⁺-dioleate (−379.2 kcal/mol) with that of the sulfur-Ti³⁺-oleate (−173.8 kcal/mol) for a radical chain of sulfur highlighted the strength of binding in Ti²⁺-dioleate. The bidentate mode of the carboxylate head of oleate in the vicinity of a Ti cation was also simulated with two chains of sulfur. The binding energy of the di-sulfur reaction, in the radical state, was increased to −280.1 kcal/mol. The energy value for a di-sulfur radical in interaction with Ti³⁺-oleate (−280.1 kcal/mol) was still less than one negatively charged chain of oleate with Ti³⁺-oleate (−379.2 kcal/mol). Considering the greater availability of sulfur chains and their lower steric hindrance compared to oleate chains, sulfur radicals were still potential targets for interaction with metal ions even with less binding energy compared to ionic chains of oleate.

To prepare sulfur-oleic acid copolymers, the sulfur was initially heated to approximately 140° C. to improve its fluidity before being combined with oleic acid. Subsequently, oleic acid was added to the molten sulfur in a weight ratio of 20% with respect to the sulfur. The blending process of sulfur and oleic acid was conducted at 400 rpm and at a temperature of 140±2° C. for a duration of 18 minutes using a BM E-100L mixer (Weikang Machinery Manufacturing Company, Shanghai, China). MgO, ZnO, and TiO₂ were used separately as catalysts to facilitate the reaction between sulfur and oleic acid. Each catalyst, at 0.08 wt % (based on the weight of the sulfur), was manually mixed with the sulfur powder prior to heating. The preparation of samples containing MgO, ZnO, and TiO₂ catalysts followed the same procedure as the catalyst-free samples.

Viscosity is a measure of a fluid's resistance to flow. It quantifies the internal friction between the molecules of a substance, particularly in relation to the material's physical properties and especially the molecular structure of polymers. In polymers, the chain length and branching affect the viscosity. Longer chains lead to higher viscosity, while branching can reduce it. The intermolecular forces, such as entanglements, also impact viscosity.

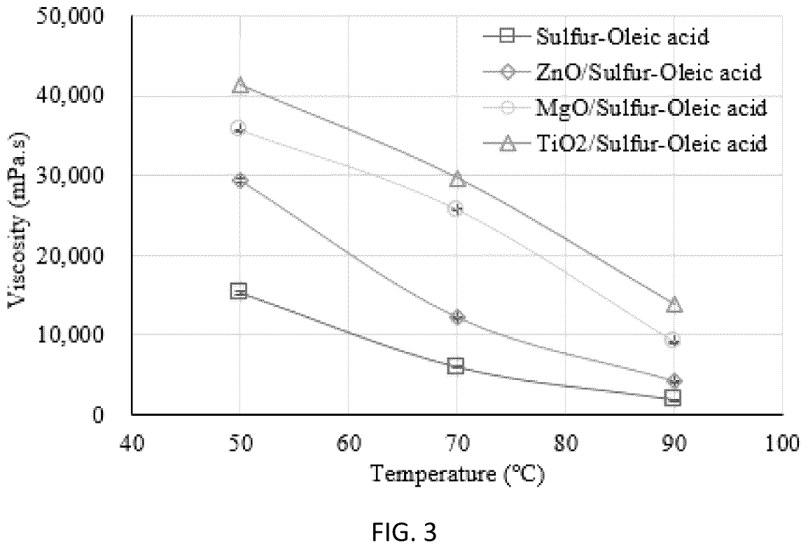

The viscosity tests in this example were conducted at temperatures of 50° C., 70° C., and 90° C., while maintaining a constant rotational speed of 10 rpm [ASTM D4402]. A cylindrical spindle (SC28) was used to apply the shear stress within the allowable torque limits. Three replicates were performed for each viscosity measurement, The viscosity for the blends of sulfur-oleic acid without catalyst and with each of three catalysts (e.g., ZnO, MgO, TiO₂), at three temperatures (e.g., 50° C., 70° C., and 90° C.) are shown in FIG. 3.

The change of viscosity can be used to indirectly characterize the inverse vulcanization process. In this process, the sulfur reacted with the oleic acid to form a highly crosslinked polymer. As the crosslinking degree increases, the viscosity of the sulfur-oleic acid blend gradually increased. The change in viscosity can be caused by the change in intermolecular interactions between the molecules. In the inverse vulcanization process, the formation of new bonds can affect the intermolecular interactions and increase the resistance of the matrix to applied shear forces, which in turn is reflected in an increase in viscosity. In addition, with the progress of the reaction, the degree of polymerization increases, which can also lead to an increase in viscosity. Therefore, the change in viscosity can be used to understand the degree of polymerization and the reaction progress of the sulfur-oleic acid blend during the inverse vulcanization process.

The viscosity of sulfur-oleic blends dropped with temperature. Introducing various metal oxides led to an increase in the viscosity of sulfur-oleic blends. The viscosities of the sulfur-oleic blends containing ZnO, MgO, and TiO₂ at 50° C. were 92.6%, 134.2%, and 171.4% higher than those without catalysts, respectively. The corresponding increases at 70° C. were 104.3%, 332.7%, and 399.8%, and at 90° C. were 121.4%, 386.8%, and 637.3%. These values suggested that the metal oxides had a catalytic effect on the inverse vulcanization process of sulfur and oleic acid. Among the three metal oxides, TiO₂ exhibited the highest catalytic activity, followed by MgO. ZnO also enhanced the inverse vulcanization process. The three metal oxides effectively accelerated the inverse vulcanization process, with TiO₂ being the most effective.

### Example 2. Sulfur Polymerization Using a Silver Grass-Biochar Biogenic Catalyst

To prepare the sample catalyzed by silver grass-biochar, 1% of the total mass of sulfur, silver grass-biochar was added to a pressure-resistant bottle. The sealed pressure-resistant bottle was heated in an oil bath at 160° C. for 1 hour and 20 minutes. Subsequently, the pressure-resistant flask was transferred to an oven at 120° C. to anneal for 36 hours. The preparation of the sample catalyzed by Zn(DTC)₂ was the same as for the sample catalyzed by silver grass-biochar. Zn(DTC)₂ also accounted for 1% of the total mass of the reactant (sulfur).

DSC tests were performed by a Q2000 DSC (TA instruments). The method was heat/cool/heat for three cycles at a heating/cooling rate of 10° C. min⁻¹ and ranging from −30° C. to 150° C.

Evaluation of the inorganic constituents of a silver grass-biochar sample was carried out using inductively coupled plasma optical emission spectrometry (ICP-OES). The instrument was fine-tuned and calibrated for 14 specific analytes/metals, following the recommended wavelengths provided by the manufacturers of the equipment. To calibrate the instrument, a multi-element metals standard containing 13 elements and a single-element standard for phosphorous (P) were used. The digestion and analytical procedures followed those described in the literature. Research-grade, highly pure concentrated nitric acid (HNO₃) and hydrochloric acid (HCl) were used as received.

MISTI is a measure of the ratio between the degree of shear thinning under wet conditions and the degree of shear thinning under dry conditions. This index is calculated using Equation 1. The MISTI value is a reliable measure of moisture-induced deterioration in the target matrix. A MISTI value of 1 indicates that there are no noticeable changes at the interface after water conditioning. Any value different from 1 suggests that there have been changes at the interface caused by exposure to water. The extent of the difference from 1 is directly related to the likelihood of moisture damage; a higher MISTI value indicates a more substantial modification at the interface.

$$MISTI = \frac{\begin{matrix}Average Slope \\ ( Viscosity vs Shear rate ) of Wet Specimen\end{matrix}}{\begin{matrix}Average Slope \\ ( Viscosity vs Shear rate ) of Dry Specimen\end{matrix}} \qquad ( Eq . 1 )$$

To create a reliable and reproducible test that accounts for the fundamental material properties driving moisture damage at the interface, 100-micron glass beads to sulfur polymer at a weight ratio of 1:2 (glass beads to sulfur) was introduced.

To conduct the test, four specimens (0.3 gram each) were prepared and molded using 8-mm silicon molds. Afterwards, two samples were subjected to ambient conditions, while the other two samples were subjected to water conditioning at a temperature of 60° C. for a duration of 24 hours. After the surface-drying process, each specimen was subjected to a shear-rate sweep test at a temperature of 64° C. The shear rate ranged from 0.1/sec to 100 l/sec. The plot of viscosity versus shear rate was subsequently used to calculate the shear-thinning value, which quantifies the extent of viscosity change with respect to the shear rate.

The M SCR test was conducted following AASHTO TP 70 using an Anton Paar dynamic shear rheometer with an 8-mm spindle. The test evaluated the rheological properties of the material under intermediate-temperature conditions (e.g., 35° C.) when subjected to repeated loading and rest cycles. The M SCR test procedure involved applying stress levels of 0.1 and 3.2 K Pa in succession to a sulfur-polymer sample. Each stress level underwent ten creep and recovery cycles, where each cycle included a 1-second creep (load application) period followed by a 9-second recovery (load removal) period. The total test duration was 200 seconds for the 20 cycles conducted across both stress levels. The M SCR test was used to derive two critical parameters: non-recoverable creep compliance (Jnr), which indicates a material's tendency to undergo permanent deformation; and percent recovery, which indicates a material's capability to recover its original form after the removal of stress. These parameters, obtained under controlled stress levels and cycle conditions, offered an insight into a material's resistance to rutting and its elastic recovery, which can aid in designing and assessing durable materials. As part of the testing, some of the samples were submerged in water at 60° C. for 24 hours to evaluate the effect of water on these polymers.

Identifying the thermodynamically stable structure of elemental sulfur and its corresponding polymeric chains can aid in optimizing species and for selection of an appropriate exchange-correlation functional for comprehensive analysis. DFT and other theoretical approaches have been used to understand the conformational and thermodynamic characteristics of S₈ rings. Additionally, ab initio molecular dynamics simulations have been conducted to investigate the opening of S₈ rings under elevated temperatures and pressures. Based on results from time-dependent DFT (TD-DFT) and highly correlated wave function STEOM-CCSD, ring-to-chain structural relaxation of elemental sulfur upon photoexcitation and/or thermal excitation was associated with formation of a diradical S₈ chain in triplet state. This transformation occurred from a closed-shell singlet configuration of the S₈ ring, which originally has a crown-shaped geometry (D4d symmetry). The bond lengths along the S₈ ring are nearly identical, 2.100 Å; and are in good agreement with the experimental data for the orthorhombic sulfur a-crystal, where the bond lengths were in the range of 2.038 Å to 2.052 Å.

The energy optimizations on biochar compounds, sulfur molecules, and their corresponding adsorption complexes were performed via the DMol³ module implemented in the Accelrys Materials Studio program package. While PBE (Perdew-Burke-Ernzerhof) formulation of generalized gradient approximation (GGA) has been used as the exchange-correlation functional in describing the molecular structure of biochar, the results showed that the PBE functional embedded in the DMol³ module was not successful in presenting an accurate molecular structure of a sulfur chain representing polymeric sulfur at temperatures above the melting point. For example, the molecular structure of S₈ optimized under the PB E functional deviated from the experimentally observed or reference bond lengths, which typically fall within the range of 2.11 Å. In this example, PB E calculations resulted in a disintegrated S₈ structure with four bond lengths exceeding 3.58 Å. This deviation was also observed in the case of the sulfur chain containing six sulfur atoms (S₆), where certain bond lengths were elongated, reaching approximately 3.6 Å.

In contrast to the PBE functional, Perdew-Wang's exchange-correlation functional (PW 91) presented a molecular structure for S₈ that more closely aligned with the experimentally defined structure: a crown-shaped geometry (D4d symmetry) featuring S—S bond lengths of 2.09 Å. The chain configuration of sulfur under the PW 91 functional illustrated shorter bonds at two ends of the chain (1.96 Å), suggesting the localization of spin density at these extremities and aligning with the diradical nature of the S₆ chain.

Molecular structures and their corresponding interactions were conducted using the PW 91 exchange-correlation functional. The Ortmann-Bechstedt-Schmidt (OBS) method was used, implemented in the DMol³ module of the Accelrys Materials Studio program package, to incorporate the long-range van der Waals interactions into the calculations. This allowed for the estimation of the thermodynamic stability and strength of adsorbent-adsorbate interactions. The calculations were performed under the GGA/PW91-OBS method. The optimization process was defined as all-electron double numerical basis sets augmented by polarization functions (DNP). “Fine” grid was specified for the matrix numerical integrations. At this level of integration, the tolerances for energy, maximum force, and displacement convergence were 1.0×10⁻⁵ Hartree, 2.0×10⁻³ Hartree/Å, and 5.0×10⁻³ Å, respectively.

In this example, silver grass-biochar was used as a biogenic catalyst, focusing on its multi-metal active sites. These metal constituents played a role as catalysts in the catalyzed inverse vulcanization process, facilitating the reactions involved in sulfur cross-linking. Unlike catalysts such as metal diethyldithiocarbamate, silver grass biogenic catalyst offers a sustainable alternative for enhancing the inverse vulcanization process.

To gain an insight into the composition of silver grass biochar, ICP-OES analysis was conducted. Table 1 shows the presence of various inorganic elements in the biochar, highlighting its metal content. The identified metals, such as Si, Fe, Mg, Zn, and Ti, contributed to the multifaceted active sites for catalyzing inverse vulcanization reactions.

TABLE 1
Elemental Composition of Biogenic Catalyst
Derived from Silver Grass Biochar (mg/kg)

| Si | Ca | K | Al | Na | Fe | P | Mg | Mn | Zn | Pb | Ti |
|---|---|---|---|---|---|---|---|---|---|---|---|
| 8611 | 4865 | 5728 | 2798 | 1052 | 1928 | 1131 | 619 | 747 | 422 | 68 | 18 |

To evaluate the catalytic efficiency and effectiveness of the target catalyst in facilitating sulfur cross-linking reactions, a two-step reaction experiment was conducted. This process involved initiating ring-opening polymerization at 160° C., followed by an annealing stage at 120° C., allowing the complete consumption of residual sulfur in the system. Typically, annealing refers to a heat-treatment process that involves heating a material to a specific temperature and then cooling it slowly. This process can be used to relieve internal stresses, enhance material properties, or optimize its microstructure. At the end of the process, the sulfur catalyzed by silver grass-biochar does not show any visible residual sulfur in the glass tube, suggesting the effective consumption of residual sulfur and the completion of the inverse vulcanization process.

Not all biochars have the inherent capability to be completely involved in the inverse vulcanization process, particularly at the first stage of heating (160° C.). For example, other biochars (e.g., wood pellet) required more complex reaction conditions to achieve inverse vulcanization. This can be observed from the distinct sulfur residue in the glass tube during the initial reaction at 160° C. Following the subsequent annealing stage at 120° C., the sulfur residue disappeared, suggesting the successful consumption of residual sulfur and the achievement of the inverse vulcanization process.

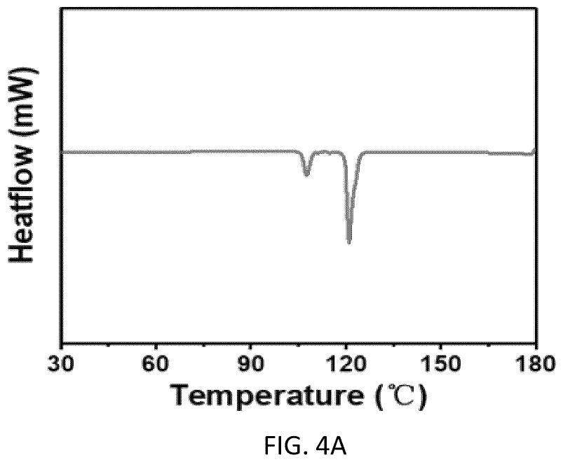

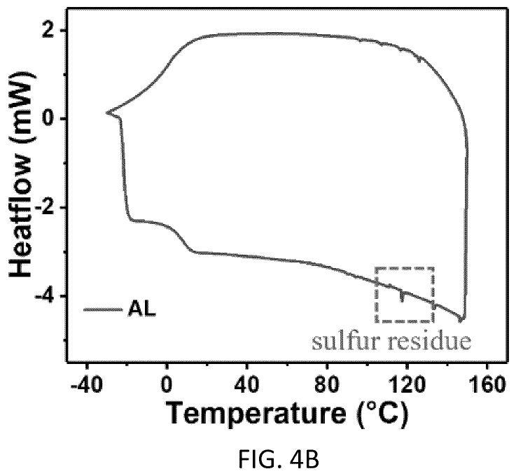

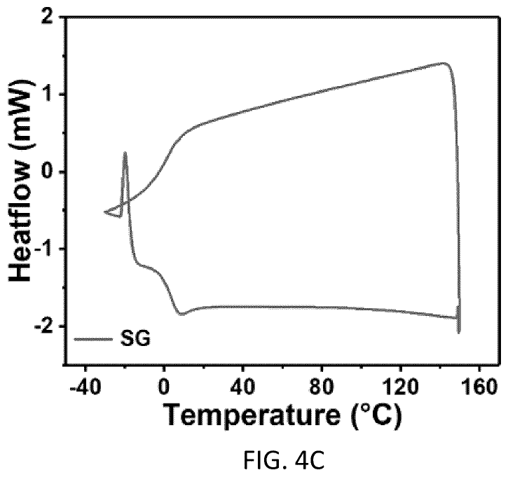

DSC analysis was conducted to assess whether there was sulfur residue in the final product. Pure sulfur underwent a solid-solid orthorhombic-monoclinic transformation at about 106° C., and melted after further heating at 118° C., as shown in FIG. 4A. The DSC graph of the silver grass-biochar catalyzed sulfur sample was compared with that of another sulfur sample catalyzed by a different biochar, algae (AL), as shown in FIGS. 4B and 4C. Referring to FIG. 4B, a crystalline melting peak of elemental sulfur in the algae-catalyzed sample appeared between approximately 118° C. and 120° C., suggesting the presence of sulfur residues. However, as shown in FIG. 4C, this peak associated with elemental sulfur was absent in the silver grass-biochar catalyzed sulfur sample, suggesting the complete consumption of sulfur in the silver grass-biochar sample.

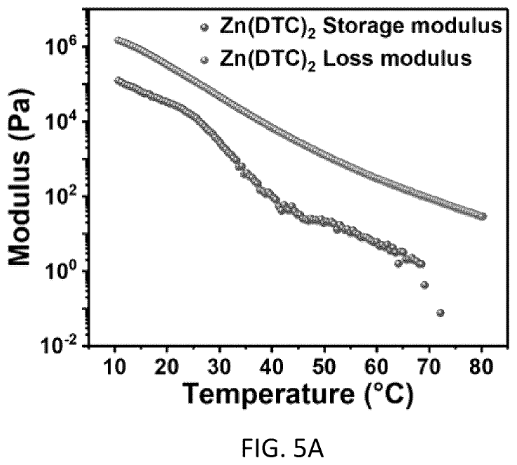

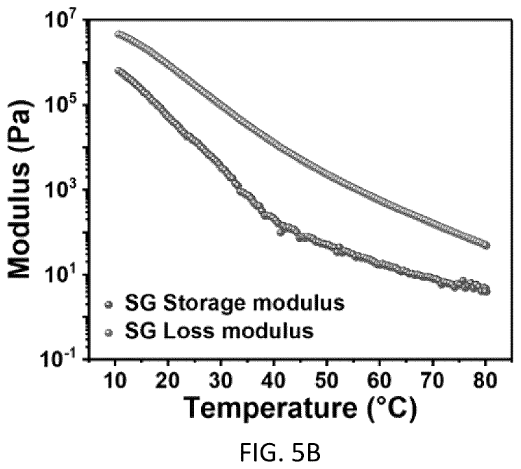

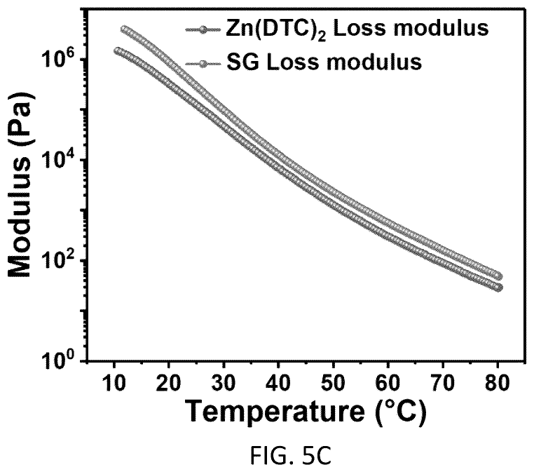

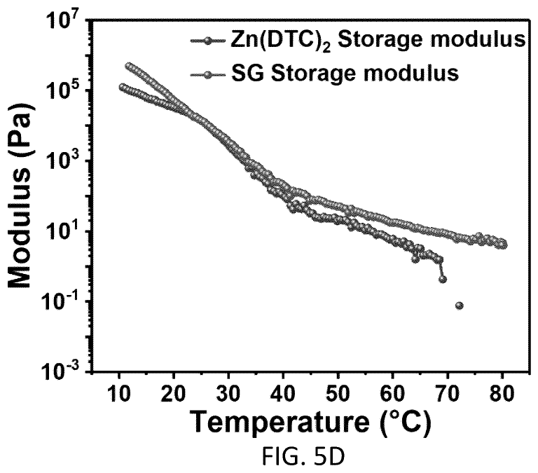

FIGS. 5A-5D show the rheological profiles conducted at 10° C. to 80° C. for two sulfur-polymer samples: one catalyzed with a silver grass biogenic catalyst, and one catalyzed with Zn(DTC)₂. The graphs of storage modulus and loss modulus showed viscoelastic characteristics for each sample. Referring to FIG. 5A, with the increase of temperature, the storage modulus of the sample catalyzed by Zn(DTC)₂ decreased more than that of the loss modulus, suggesting that the elastic properties of Zn(DTC)₂ sample were gradually lost at high temperature, and it was fluid at 80° C. In contrast, the storage modulus of the sample catalyzed by silver grass-biochar had a similar trend as the loss modulus with increasing temperature, and it still retained certain elastic properties at 80° C., as shown in FIG. 5B. Referring to FIG. 5C, the loss modulus of the samples catalyzed by silver grass-biochar and by Zn(DTC)₂ had a similar trend with temperature. However, the storage modulus of Zn(DTC)₂ decreased more, suggesting that the elastic properties of silver grass-biochar polymers are better preserved at higher temperatures, as shown in FIG. 5D.

As shown in Table 2, there are differences in the rheological responses of the two sulfur formulations at the specified temperatures. The absence of sulfur residue at 160° C. in both the silver grass-biochar and the Zn(DTC)₂ samples highlighted the sulfur consumption achieved by both catalysts. The silver grass-biochar polymer demonstrated enhanced elastic properties from 10° C. to 80° C. over Zn(DTC)₂ polymer in terms of storage modulus. As the temperature increased to 80° C., silver grass-biochar polymer maintained a higher storage modulus than polymer obtained with Zn(DTC)₂.

TABLE 2
Comparative rheological analysis: silver-grass catalyst
and Zn(DTC)₂ catalyst in inverse vulcanization process

| | | Storage | Storage | Loss | Loss |
|---|---|---|---|---|---|
| | Sulfur | modulus | modulus | modulus | modulus |
| | residue | at 10° C. | at 80° C. | at 10° C. | at 80° C. |
| Silver Grass | NO | 6.24E5 | 4.0 | 4.58E6 | 48.1 |
| Zn(DTC)₂ | NO | 1.23E5 | 0.0 | 1.47E6 | 29.4 |

The values obtained for the loss modulus at both 10° C. and 80° C. provided an insight into the behaviors between the two catalysts. At 10° C., the silver grass-biochar polymer exhibited a higher loss modulus (4.58E6) compared to the Zn(DTC)₂ produced polymer (1.47E6), suggesting a tendency for energy dissipation and a more viscous behavior in the silver grass-biochar polymer. This trend continued at 80° C., where the silver grass-biochar polymer loss modulus (48.1) surpassed that of Zn(DTC)₂ polymer (29.4). These results highlighted the silver grass-biochar performance at facilitating the inverse vulcanization process, showing enhanced viscous characteristics compared to the conventional chemical catalyst Zn(DTC)₂.

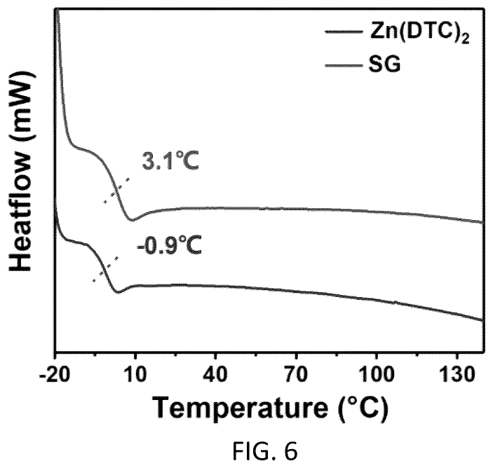

The glass transition temperature (T_{g}) is another indicator of a material's mechanical properties. In this context, the T_{g} values for samples catalyzed by Zn(DTC)₂ and silver grass-biochar were compared in FIG. 6. The sample catalyzed by Zn(DTC)₂ demonstrated a T_{g} of −0.9° C., while the sample catalyzed by silver grass-biochar exhibited a higher T_{g} of 3.1° C. This difference suggested that the sample catalyzed by silver grass-biochar has stronger mechanical properties compared to the one catalyzed by Zn(DTC)₂. A higher T_{g} suggested that the material required more energy to transition from a rigid to a more flexible state, implying enhanced mechanical stability and strength in the silver grass-biochar catalyzed sample.

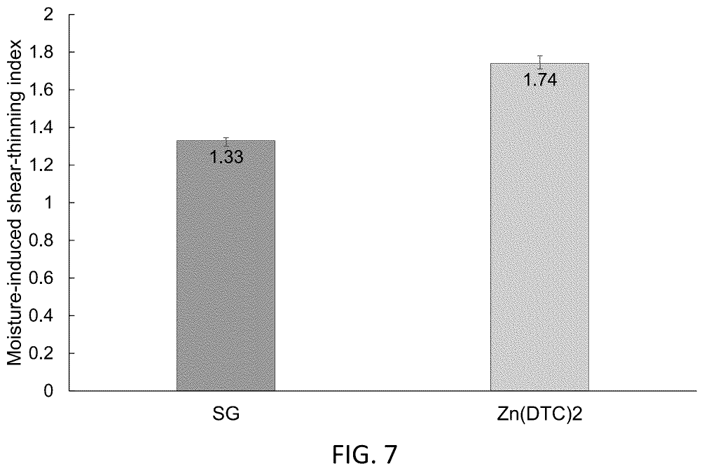

FIG. 7 shows the MISTI of two sulfur-polymer samples: one catalyzed by the silver grass biogenic catalyst, and one catalyzed by Zn(DTC)₂. The rheological property of shear thinning is influenced by variations in interfacial bonding. The shear-thinning test can be used for detecting alterations at the interface by manipulating the surface chemistry of siliceous particles and modifying the interfacial connection. The relationship between shear rate and viscosity in the shear-thinning zone can be dictated at least by the molecular interaction of the bitumen matrix. A greater degree of interaction typically correlates with a more pronounced decrease in viscosity with increasing shear rate. A higher shear-thinning value (e.g., power-law slope) suggests increased interaction between the polymer and the glass beads.

Referring to FIG. 7, the MISTI values for both sulfur-polymer samples (one catalyzed by the silver grass biogenic catalyst and one catalyzed by Zn(DTC)₂) exhibited deviations from 1, suggesting varying degrees of moisture susceptibility in the target polymers. However, upon comparing the two samples, the sulfur polymer catalyzed by silver grass-biochar exhibited more resistance to moisture damage compared to the polymer catalyzed by Zn(DTC)₂. The lesser deviation of the silver grass-biochar sulfur polymer from 1 (0.33) compared to the Zn(DTC)₂ sulfur polymer (0.74) suggested better intermolecular interactions between the silver grass-biochar sulfur polymer and glass beads.

Considering the hydrophobic nature of orthorhombic elemental sulfur, the moisture susceptibility of sulfur polymers made with the silver grass-biochar or Zn(DTC)₂ could be attributed at least to the presence of polymeric chains of sulfur that still remain in the matrix. One of the mechanisms proposed for the moisture susceptibility of sulfur-containing polymers is the thermal decomposition of polysulfides (R—Sn—R) upon heating that leads to the formation of thiols (RS—H), which can interact with water molecules. A part of the moisture susceptibility could also be attributed to those sulfur compounds that have been functionalized with hydrophilic groups, such as sulfonate, sulfoxide, or other functional groups containing oxygen.

The improved performance of the silver grass-biochar sulfur polymer can be attributed at least in part to the effectiveness of the silver grass-biochar catalyst in sulfur consumption and the formation of a better network. This effectiveness was suggested by the absence of sulfur residue and a higher storage modulus, indicating enhanced crosslinking and improved resistance to moisture damage compared to the sulfur polymer made with the Zn(DTC)₂ catalyst. Furthermore, it is likely that the silver grass-biochar catalyst facilitated ring-opening polymerization and sulfur consumption, resulting in a polymer with stronger intermolecular interactions with glass beads and greater resistance to moisture damage compared to the Zn(DTC)₂ catalyst.

Table 3 shows the average recovery percent and non-recoverable creep compliance at two stress levels. Jnr is a measure of the non-recoverable (permanent) deformation. A lower value of Jnr suggests better resistance to permanent deformation (rutting). In dry conditions, the Jnr values typically ranged from 0.02 kPa⁻¹ for the silver grass-biochar polymer, indicating good resistance to deformation. For the Zn(DTC)₂ polymer, a value of 0.67 kPa⁻¹ was observed, indicating a relatively lower resistance to deformation. The transition to wet conditions increased the Jnr values for both samples, with the silver grass-biochar polymer increasing from 0.02 kPa⁻¹ to 0.13 kPa⁻¹, and the Zn(DTC)₂-polymer increasing from 0.67 kPa⁻¹ to 0.86 kPa⁻¹. This increase suggested that moisture affects the polymer performance, with the Zn(DTC)₂ polymer showing higher susceptibility to permanent deformation under loading, marking it as the less resilient polymer. The silver grass-biochar polymer demonstrated resilience in dry conditions; though its performance decreased under wet conditions, it still outperformed sulfur-Zn(DTC)₂ in resisting deformation. This trend suggested that water immersion at an elevated temperature can induce changes in the polymer's microstructure, potentially by reducing the sulfur cross-linking within its molecular network, resulting in a softer polymer more prone to deformation.

TABLE 3
Average recovery percentage and non-recoverable creep
compliance measured under 0.1 KPa and 3.2 KPa.

| | | | | Jnr_{0.1} | Jnr_{3.2} |
|---|---|---|---|---|---|
| Sample | Condition | R_{0.1} (%) | R_{3.2} (%) | kPa⁻¹ | kPa⁻¹ |
| Silver grass- | Dry | 2.65 | 2.40 | 0.02 | 0.02 |
| biochar | Wet | 0 | 0 | 0.10 | 0.13 |
| Zn(DTC)₂ | Dry | 0 | 0 | 0.67 | 0.69 |
| | Wet | 0 | 0 | 0.78 | 0.86 |

Percent recovery indicates the elastic response of the material, representing the percentage of strain that is recovered after the removal of the applied stress. It can be a direct indicator of the elastic component of the polymer formed. The percentage recovery (R) analysis provided further insight into understanding of material performance under stress. In dry conditions, the silver grsas-biochar polymer showed recovery percentages of 2.65% and 2.40% under 0.1 K Pa and 3.2 K Pa stress conditions, respectively, indicating the ability to recover post-deformation. In contrast, the Zn(DTC)₂ polymer showed negligible recovery in either dry or wet conditions, highlighting a lack of elasticity at the test temperature. The absence of recovery in the sulfur polymer catalyzed by Zn(DTC)₂ suggested that it is more prone to permanent deformation when subjected to repeated loading, while the silver grass-biochar polymer displayed better performance in terms of elasticity.

The silver grass-biochar polymer was better performing in terms of Jnr values in dry settings, suggesting it has a higher resistance to permanent deformation. However, its performance decreased in moist conditions. The Zn(DTC)₂ polymer was identified as the less effective polymer at least in part because of its elevated Jnr values in both dry and wet scenarios, suggesting it is prone to irreversible deformation. The shift from dry to wet circumstances resulted in a decline in binder performance, as indicated by an increase in Jnr values for all samples. This suggested the influence of moisture on polymer flexibility, highlighting the benefit of binders that can uphold performance consistency in different environmental circumstances.

Direct synthesis of polymers from sulfur typically utilizes a ring-opening polymerization. This synthesis is a reversible reaction through which terminal sulfur radicals depolymerize and expel S₈ or other cyclic sulfur species, so the radicals are usually quenched to provide stable polymers. Small organic molecules can be used as crosslinkers to trap sulfur radicals and suppress depolymerization. However, many crosslinkers, such as ethylene glycol dimethacrylate, can be unreactive to sulfur even at temperatures over 200° C.

In catalyzed inverse vulcanization, a catalyst such as a metal-diethyldithiocarbamate (metal-(DTC)₂) was introduced into the process, facilitating reactions to occur at lower temperatures. However, the classification of metal-(DTC)₂ as a catalyst, initiator, or activator can be unclear at least in part because of the absence of a proposed catalytic mechanism.

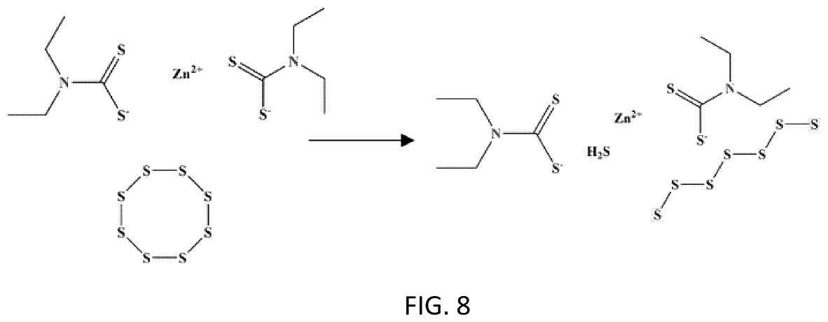

To compare a well-known catalyst such as Zn(DTC)₂ with specific catalytic compounds present in silver grass-biochar, the interaction between Zn(DTC)₂ and S₈ molecules was assessed at the GGA/PW91-OBS/DNP level of DFT calculations, as shown in FIG. 8. The catalytic process involved formation of coordination complexes between the catalyst and sulfur atoms. As shown in FIG. 8, this reaction is associated with the release of one H₂S molecule, resulting from the separation of a sulfur atom within the S₈ structure and leaving a chain sulfur.

The examination of the optimized Zn(DTC)₂ . . . . S₈ complex showed that the crown-shaped geometry of S₈, characterized by bond lengths of approximately 2.1 Å, underwent a breakage at two points (S₁-S₂ and S₁-S₈). This modification likely led to the isolation of a sulfur atom (S₁) and the creation of a sulfur chain consisting of seven atoms, while certain S—S bonds (S3-S4, S5-S6, and S7-S8) extended from about 2.1 Å to roughly 3.6 Å. While the separated sulfur atom (S₁) can give rise to an H₂S gas molecule, a closer examination of the S—S bonds and consideration of the typical sulfur bond lengths (about 2.1 Å) suggested that the S₁ atom was coordinated to the Zn atom with a bond length of 2.36 Å. This interaction can result in the formation of three S═S bonds, the release of an isolated S₈ atom producing H₂S gas, and the coordination of Zn with S₁.

To examine the effectiveness of biogenic catalysts in silver grass-biochar, the patterns of S—S bond breaking and loosening were followed in the presence of these catalysts, contrasting their performance with that of Zn(DTC)₂ against S₈ molecules. The selected catalytic compounds from biochar were two N-containing compounds, carbazole and quinoline, containing Zn and Mg metal atoms. Carbazole contains an indole ring and quinoline contains a pyridine ring. Zn and Mg metal atoms were coordinated with the nitrogen compounds through C—N bonds. Carbazole and quinoline compounds were chosen at least in part because of the superior thermal stability exhibited by N-containing compounds, such as pyridinic-N, pyrrolic-N, and quaternary-N, during biochar preparation. Both catalysts and their interactions with S₈ were optimized at the GGA/PW91-OBS/DNP level of DFT calculations.

The two target metal atoms chosen for this study, Zn and Mg, were taken from the list of metals identified in the elemental composition of silver grass-biochar, as shown in Table 1. While the concentrations of Mg (0.6 gr/Kg) and Zn (0.7 gr/Kg) were lower than other impactful metals in the table, such as Ca (4.9 gr/Kg), Al (2.8 gr/Kg), and Fe (1.9 gr/Kg), the selection of Zn was based on its presence in Zn(DTC)₂. Similarly, Mg was chosen at least in part because of its high concentration in this specific biochar compared to other biochars such as acacia and wood pellet, which can exhibit a less-effective performance as biogenic catalysts compared to silver grass.

The pattern of Zn—S bond formation in reaction of S₈ with Zn-quinoline and Zn—carbazole showed a higher degree of Zn—S coordination compared to Zn(DTC)₂, with a ratio of 3:1. The coordinated sulfurs were then available for further reactions with other organic compounds within the matrix, contributing to reduced depolymerization of sulfur chains.

In contrast to Zn-quinoline and Zn-carbazole, Mg-catalysts did not exhibit dative coordination with sulfur atoms. This characteristic can arise from the chemical nature of magnesium, an alkaline earth metal with two valence electrons in the outermost shell. This limitation can restrict Mg interactions with sulfur to electrostatic interactions rather than forming covalent bonds. The DFT investigation into the efficacy of biogenic catalysts in silver grass-biochar, particularly carbazole and quinoline, showed patterns of S—S bond breaking. Coordinated Zn-quinoline and Zn-carbazole exhibited superior Zn—S coordination, fostering subsequent reactions within the matrix and reducing the depolymerization of sulfur chains.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A method of synthesizing a polysulfide copolymer by inverse vulcanization, the method comprising:
combining elemental sulfur with a biogenic catalyst to yield a first mixture;
heating the first mixture to form a melt comprising polysulfide chains;
combining one or more unsaturated fatty acids with the melt to yield a second mixture, and
copolymerizing the polysulfide chains and the one or more unsaturated fatty acids in the second mixture to yield the polysulfide copolymer.

2. The method of claim 1, wherein the elemental sulfur comprises waste sulfur.

3. The method of claim 2, wherein the waste sulfur is a by-product of hydrodesulfurization processing.

4. The method of claim 1, wherein the biogenic catalyst comprises biochar.

5. The method of claim 4, wherein the biochar comprises two or more metals.

6. The method of claim 5, wherein the two or more metals are selected from Si, Ca, K, Al, Na, Fe, P, Mg, Mn, Zn, Pb, and Ti.

7. The method of claim 4, wherein the biochar comprises biochar from algae, grasses, wood, shells, crops, crop waste, or organic waste.

8. The method of claim 7, wherein the wood comprises pine, acacia, walnut, fir, and birch.

9. The method of claim 7, wherein the grasses comprise miscanthus.

10. The method of claim 7, wherein the organic waste comprises waste from wastewater treatment processes, paper mills, sawmills, or breweries.

11. The method of claim 1, wherein each of the one or more unsaturated fatty acids has 12-22 carbon atoms.

12. The method of claim 11, wherein the one or more unsaturated fatty acids comprise linoleic acid, oleic acid, or a combination thereof.

13. The method of claim 1, wherein the one or more unsaturated fatty acids are derived from one or more plant-based oils.

14. The method of claim 13, wherein the one or more plant-based oils comprise canola oil, linseed oil, sunflower oil, olive oil, or any combination thereof.

15. The method of claim 14, wherein the one or more plant-based oils comprises waste vegetable oil.

16. The method of claim 1, wherein a weight ratio of a total amount of the one or more unsaturated fatty acids to the elemental sulfur is in a range of about 0.1 to about 0.3.

17. The method of claim 1, wherein a weight ratio of a total amount of the biogenic catalyst to a total amount of sulfur is in a range of about 0.0001 to about 0.001.

18. The method of claim 1, wherein heating the first mixture comprises heating in a temperature range of about 130° C. to about 170° C.

19. The method of claim 1, wherein copolymerizing comprises heating in a temperature range of about 110° C. to about 145° C.

20. The method of claim 1, wherein the one or more unsaturated fatty acids comprise oleic acid, and the biogenic catalyst comprises Ti, Mg, or Zn.

21. The method of claim 20, wherein a catalytic activity of the biogenic catalyst comprising Ti exceeds a catalytic activity of the biogenic catalyst comprising Mg, and the catalytic activity of the biogenic catalyst comprising Mg exceeds a catalytic activity of the biogenic catalyst comprising Zn.
